(19) United States
(12) Patent Application Publication
(10) Pub. No.: US 2018/0317678 A1
(43) Pub. Date: Nov. 8, 2018

(54) Portable Headrest for the Prone Body Position, for Personal Use and as an Aid to Therapy

(71) Applicant: Mario Peric, Kirchberg (CH)

(72) Inventor: Mario Peric, Kirchberg (CH)

(21) Appl. No.: 15/772,899

(22) PCT Filed: Nov. 8, 2016
(86) PCT No.: PCT/CH2016/000141

§ 371 Date: May 2, 2018

(30) Foreign Application Priority Data
Nov. 9, 2015 (CH) 1621/15

(51) Int. Cl. A47G 9/10; A61G 13/12

(52) U.S. Cl. CPC A47G 9/1054; A47G 9/1009; A61G 2200/325; A47G 2009/1018; A61G 13/1215

(57) ABSTRACT

A portable headrest which has a forehead support and a chin support and a recess between the forehead support and chin support. The portable headrest can especially be constructed in such a way that the forehead support and/or chin support is/are adjustable in height and/or length. The headrest can optionally include a rounded attachment. Furthermore, the headrest can include at least one camera is arranged in the recess between the forehead support and chin support.

The invention relates to a portable headrest which is used in a prone body position.

In accordance with the prior art, in the prone position it was previously necessary to turn the head to one side. This gives rise to strain on the cervical vertebral region, which can result in consequences to health.

The present invention now offers an improved headrest which overcomes the disadvantages of the headrests from the prior art.

The problem underlying the invention is solved according to the invention by a portable headrest, as specified by the features of independent patent claim 1. Further advantageous aspects will be apparent from the features of the dependent patent claims.

In the prone body position the head is supported in a straight position, with the result that the cervical vertebral region is relieved of strain and the spinal column and neck musculature are brought into a beneficial and strain-relieving position.

The core of the invention lies in the following: a portable headrest has a forehead support and a chin support and a recess between the forehead support and chin support. Such a portable headrest is used, with the forehead support and chin support, to support the head and serves as an aid to therapy.

In the lying position which is facilitated by the portable headrest according to the invention, the forehead and chin are supported in a controlled way and the cervical vertebral region is relieved of strain and the spinal column and neck musculature are automatically brought into a beneficial and strain-relieving position. As a result it is possible for chronic pain in the cervical vertebral column and shoulders as well as tension in the back of the neck and headaches to be reduced.

The headrest according to the invention has the advantages that in the prone body position the head remains held in a straight position, with the forehead and chin being supported in a controlled way.

In a preferred embodiment, the portable headrest is constructed in such a way that the forehead support and/or chin support is/are adjustable in height and/or length.

Such adjustability serves for compensating for different head sizes and head anatomies. The space between forehead and chin is largely free in order to ensure free breathing.

The forehead support or the chin support or both the forehead support and the chin support can be adjustable either only in height or only in length or in height and in length. Such adjustability serves for better adaptation of the portable headrest to the head and body of the patient.

In a special embodiment, the forehead support and/or the chin support can have an anatomical shape in order to be better able to adapt to the head of the patient.

In a further preferred embodiment, the portable headrest is constructed in such a way that both the forehead support and the chin support are adjustable in height and/or length. In that case the portable headrest is especially constructed in such a way that the forehead support and the chin support are adjustable in height and/or length independently of one another, preferably being adjustable both in height and in length.

If the forehead support is adjustable independently of the chin support, the scope for adjustment is especially suitable for adaptation of the headrest to the anatomy of the patient, especially if both the height and the length of the forehead support and the chin support are adjustable.

In a further embodiment, the portable headrest has a body, and the forehead support and/or the chin support are formed separately (as separate parts) from the body of the headrest. The forehead support and/or the chin support can have displacement elements, and the body of the portable headrest can have at least one displacement element that is complementary to the displacement elements of the forehead support and/or the chin support. In particular, the displacement elements on the forehead support and/or the chin support and on the body of the portable headrest are constructed in such a way that a displacement along the longitudinal axis of the portable headrest is possible. The longitudinal axis of the headrest is the axis which runs from the forehead support to the chin support parallel to the body of the headrest or parallel to the support surface of the headrest.

The forehead support and/or the chin support are provided with a rail, and the body of the headrest is provided with at least one groove complementary to the rail, the rail and the groove being arranged along the longitudinal axis of the portable headrest, so that the rail is able to co-operate with the associated groove in the body of the headrest. Alternatively, it is also possible to use other displacement elements, such as, for example, pins and complementary holes.

In this embodiment, the forehead support or the chin support can be adjusted in accordance with the longitudinal axis of the portable headrest. The rail with the complementary groove offers an especially simple, secure and flexible way of adjusting the forehead support and/or chin support.

The rail and/or the groove can be separate elements which are mounted on the forehead support and/or the chin support, or on the body of the portable headrest. The rail and/or the groove can, however, also form part of the forehead support and/or the chin support or the body of the portable headrest, for example obtainable by the injection-moulding technique. All possible implementation combinations of separate elements or one-piece elements are possible.

In a special embodiment, the forehead support and the chin support consist at least partly of a soft foam plastics material.

In a special embodiment, the body of the portable headrest consists at least partly of a soft foam plastics material.

For example, as soft foam plastics material there can be used here a polyurethane having a density of around 5 to 40 kg/m³. A soft foam plastics material made of polyester can also be used. It is also possible to use a memory foam plastics material. Such soft foam plastics materials are known to the person skilled in the art in the field of upholstery.

In this case too, the individual parts which already have a rail and/or groove can be produced in one piece by different techniques.

In a further embodiment, the contact surface between the body of the headrest and the forehead support and/or the chin support is slanted or inclined in such a way that the forehead support and/or chin support can be (simultaneously) adjusted in height and length by displacement along the longitudinal axis of the portable headrest. The contact surfaces for the forehead support and/or chin support on the body of the headrest are inclined and the contact surfaces for the body on the forehead support and/or chin support are correspondingly complementarily inclined in order to be able to co-operate with the contact surfaces on the body. The contact surfaces are inclined with respect to the underside of the body of the headrest along the longitudinal axis.

The contact surface between the body and the head or chin support is inclined especially at an angle of inclination with respect to the underside of the body of the headrest along the longitudinal axis.

In a special embodiment, the angle of inclination of the contact surface on the forehead support along the longitudinal axis is opposite to the angle of inclination of the contact surface on the chin support. That means that the slanted contact surfaces along the longitudinal axis have a change of sign in the first derivative.

In particular, the two contact surfaces on the body of the head support are directed towards the recess, that is to say the inclination of the contact surfaces is such that the contact surfaces are inclined downwards in the direction of the base of the body in the recess.

The inclination for the contact surface on the forehead support can be identical or different to the inclination of the contact surface on the chin support. The angle of inclination is especially 3° to 20°, very especially 5° to 15°.

In a further embodiment, the portable headrest has a body which has an underside and has at its underside (bottom side, opposite the forehead and chin supports) a rigid plate which extends over at least a portion of the underside. In particular, the rigid plate extends over the entire underside of the body of the portable headrest. The rigid plate can be made, for example, from aluminium. The rigid plate can be embedded in the body of the headrest.

The rigid plate contributes to the stability of the headrest and simplifies handling of the portable headrest, especially if the body of the portable headrest consists at least partly of a soft foam plastics material.

In a further embodiment, the portable headrest further comprises at least one camera which is arranged in the recess between the forehead support and chin support. The at least one camera can be arranged so as to be movable in the recess between the forehead support and chin support. The camera can be fixed to a movable arm which projects, for example, through through-holes in the body of the portable headrest into the recess between the forehead support and chin support. The wiring of the camera can be passed correspondingly via the movable arm through the through-holes in the body of the headrest.

The at least one camera can be used to observe the face of the patient undergoing therapy. In particular, such a camera can be used to observe a patient during a surgical intervention.

In a further embodiment, the portable headrest comprises a rounded attachment. The portable headrest can be used with or without the rounded attachment. The rounded attachment can especially have the shape of a spherical cap.

The attachment is preferably attachable to the underside or placement surface of the headrest having a flat plane. For that purpose, the rounded attachment is attached to the underside or placement surface of the headrest having a flat plane, the rounded attachment having a flat plane with which it can be attached to the underside (opposite the forehead support and chin support) of the body of the headrest. In particular, the rounded attachment has fixing means in order to be able to co-operate with complementary receiving means on or in the underside of the body of the headrest. In particular, the fixing means on the rounded attachment are snap-in elements which are arranged on the flat plane of the rounded attachment and are able to snap into complementary receiving elements on or in the underside of the body of the headrest.

In conjunction with the rounded attachment, if required the head, in addition to being actually supported, can at the same time be moved in all directions during personal use or by a second person. That embodiment considerably simplifies the handling of the portable headrest, especially when it is used directly by the patient. In addition, the attachment facilitates further adaptation to the requirements of the patient, such as, for example, the overall height of the portable headrest.

The portable headrest preferably has for the forehead and for the chin an (ergonomically) shaped support having a shape suitable for supporting the head in the prone body position.

The portable headrest assists in alleviating pain and relieving strain on the spinal column in cases of discomfort, tension and pain. Pain and tension are alleviated especially in the cervical vertebral region and back of the neck. Shoulder pain and headaches can also be reduced. General body recovery is also achieved by the prone body position with the head held straight (no rotation of the cervical vertebrae, cervical vertebrae in line with the spinal column).

The variants and features mentioned and described herein can likewise be implemented as a combination of two or more variants or features with one another and such combinations are likewise covered by the present invention, provided that such combinations are not mutually inconsistent.

The portable headrest according to the invention is described in greater detail below on the basis of exemplary embodiments and referring to the accompanying drawings, wherein:

FIG. 1 is a perspective view of an embodiment of the headrest according to the invention.

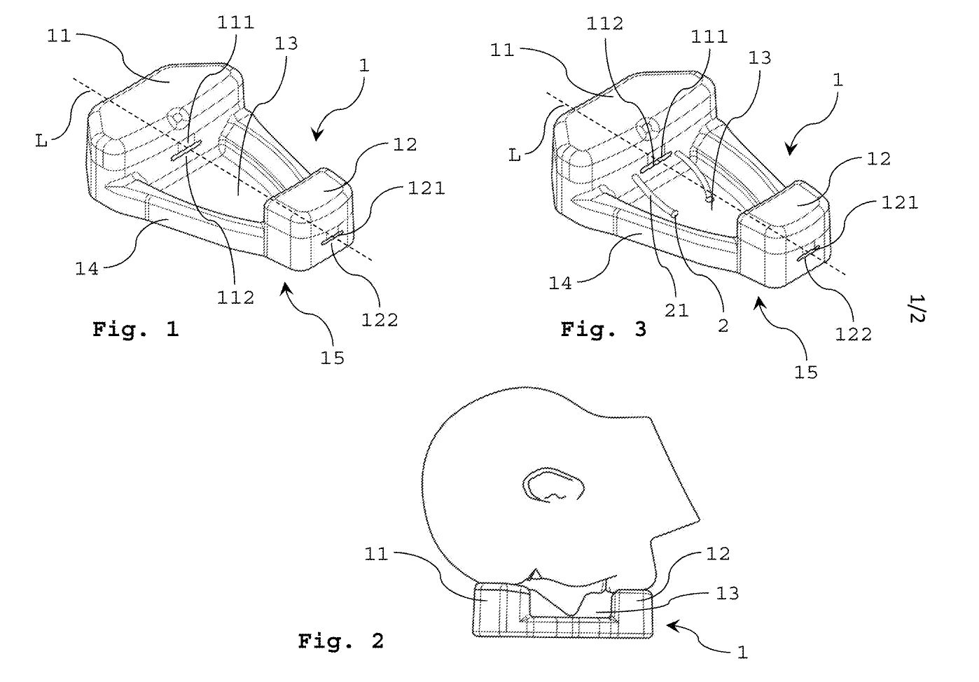

FIG. 2 shows the use of the headrest according to the invention on a patient.

FIG. 3 is a perspective view of a further embodiment of the headrest according to the invention.

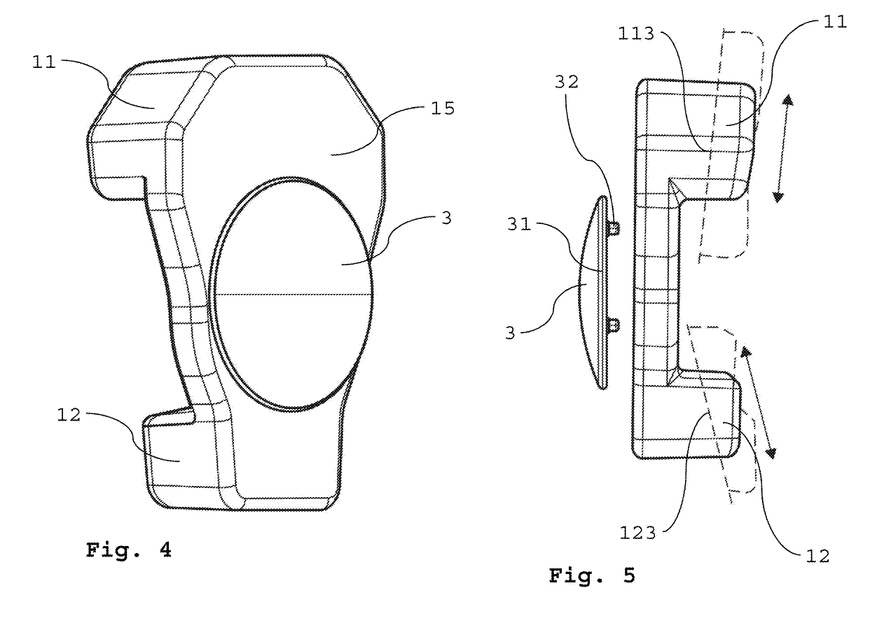

FIG. 4 is a perspective view of a further embodiment of the headrest according to the invention.

FIG. 5 is a perspective view of a further embodiment of the headrest according to the invention.

The following observation applies in respect of all the further description: where, for the purpose of clarity of the drawings, reference numerals are included in a Figure but are not explained in the directly associated description text, reference should be made to the mention of those reference numerals in preceding descriptions of the Figures.

FIG. 1 is a perspective view of the headrest according to the invention, showing a forehead support 11 and a chin support 12 as well as a recess 13 between the forehead and chin supports 11,12 for receiving the nose and mouth of the patient.

In the present embodiment of the portable headrest 1, both the forehead support 11 and the chin support 12 are adjustable in length. The forehead support 11 and the chin support 12 are adjustable in length independently of one another. This facilitates optimum adaptation of the portable headrest 1 to the anatomy of the head and the body of the patient. In the embodiment shown in FIG. 1, the forehead support 11 and the chin support 12 have been formed separately (as separate parts) from the body 14 of the headrest 1. Both the forehead support 11 and the chin support 12 are provided with a rail 111,121. The body 14 of the headrest 1 has a groove 112 in the forehead region and a groove 122 in the chin region. The grooves 112,122 are complementary to the respective rails 111,121 of the corresponding forehead support 11 and chin support 12. Both the rails 111,121 and the complementary grooves 112,122 extend along a longitudinal axis L of the portable headrest 1, so that both the forehead support 11 and the chin support 12 are displaceable along the longitudinal axis L.

In this embodiment both the forehead support 11 and the chin support 12 have been produced from a soft foam plastics material. The forehead and chin supports 11,12 can each also have, for example, fabric on their surface in order to offer the patient a more pleasant contact surface. Furthermore, the body 14 of the portable headrest 1 likewise consists partly of a soft foam plastics material. In order to impart the necessary rigidity to the portable headrest 1 during use, on the underside 15 of the body 14 there is embedded an aluminium plate which extends over the entire underside 15 of the headrest 1.

FIG. 2 shows the use of the portable headrest 1 according to the invention with reference to a person lying in the prone position. The patient lies in a relaxed prone position and, with the forehead and the chin being supported simultaneously, can nevertheless breathe freely because mouth and especially nose are located in the recess 13 between the forehead and chin supports 11, 12. When a person lies in the prone position on a flat surface, the head is supported in a controlled way on the forehead and on the chin in order that the head remains in a straight position (no rotation of the cervical vertebrae, no tension of the cervical vertebrae caused by extension).

FIG. 3 shows a further embodiment of the portable headrest 1 according to the invention. This embodiment differs from the embodiment of FIG. 1 in that two cameras 2 are arranged in the recess 13 between the forehead and chin supports 11, 12. The cameras 2 are fixed to movable arms 21 and the wiring passes through the movable arms 21. Furthermore, the movable arms 21 are connected to through-holes in the body 14. It will be understood that the number of cameras is not limited to two.

FIG. 4 shows a further embodiment of the portable headrest 1 according to the invention, comprising a rounded attachment 3, which can be mounted on and removed from the underside 15 of the headrest 1 and has a rounded support surface in the shape of a spherical cap.

FIG. 5 shows a further embodiment of the portable headrest 1 according to the invention having a rounded attachment 3, which has a flat plane 31 and with that flat plane 31 is reversibly attachable to the underside 15 of the body 14 of the headrest 1 with the aid of snap-in elements 32 in complementary receiving elements in the underside 15 of the body 14.

In addition, it can be seen from this embodiment of FIG. 5 that the forehead support 11 and the chin support 12 have been formed separately and the contact surfaces 113, 123 between the body 14 of the headrest 1 and the forehead support 11 and the chin support 12, respectively, are slanted. The angle between the slanted contact surface 113 on the forehead support 11 and the underside 15 of the body 14 along the longitudinal axis L is approximately 5° and the angle of the slanted contact surface 123 on the chin support 12 relative to the underside 15 of the body 14 along the longitudinal axis L is approximately 15°.

The forehead support 11 and the chin support 12 are connected to one another by means of a rail and groove along the longitudinal axis of the portable headrest 1. By displacement of the forehead support 11 and/or the chin support 12 along the longitudinal axis, which movements are indicated by the arrows, the height and the length of the portable headrest in the chin region and in the forehead region can be set independently of one another. As a result of the different inclination (angle) of the slanting contact surface 113 in the forehead region in comparison with the inclination (angle) of the slanting contact surface 123 in the chin region, it is again possible for an optimum height and length of the portable headrest 1 to be specifically adapted and adjusted to the anatomy of the head and the body of the patient.

It should be pointed out that the embodiment shown in FIG. 5 can likewise be used without the rounded attachment and, as in the embodiment shown in FIG. 3, can likewise be provided with at least one camera.

The invention has been explained with reference to exemplary embodiments, but is not limited to those embodiments. However, the exemplary embodiments demonstrate the high degree of versatility of the present invention and its flexibility for use in an extremely wide range of therapeutic fields, such as, for example, in the field of surgery or application in the field of massage. The portable headrest can also be used, however, in the private sphere without a therapist, since during personal use it likewise facilitates a relaxing lying position in the prone position and is easy to use. Such a lying position relieves strain on the cervical vertebral region and automatically brings the spinal column and neck musculature into a beneficial and strain-relieving position. As a result, it is possible to reduce chronic pain in the cervical vertebral column and the shoulder region as well as tension in the back of the neck and headaches. In conjunction with the rounded attachment, if required the head, in addition to being actually supported, can at the same time be moved in all directions during personal use or by a second person.

1. A portable headrest which has a forehead support and a chin support and a recess between the forehead support and the chin support.

2. The portable headrest according to claim 1, wherein the portable headrest is constructed in such a way that the forehead support and/or the chin support is/are adjustable in height and/or length.

3. The portable headrest according to claim 2, wherein the portable headrest is constructed in such a way that the forehead support and the chin support are adjustable in height and/or length independently of one another.

4. The portable headrest according to claim 1, wherein the portable headrest has a body, and the forehead support and/or the chin support are formed separately from the body of the headrest, wherein the forehead support and/or the chin support have displacement elements, and the body of the portable headrest has at least one displacement element that is complementary to the displacement elements of the forehead support and/or the chin support.

5. The portable headrest according to claim 4, wherein the forehead support and/or the chin support comprise a rail, and the body of the headrest comprises at least one groove complementary to the rail, the rail and the groove being arranged along a longitudinal axis of the portable headrest, so that the rail is able to co-operate with the associated groove.

6. The portable headrest according to claim 1, wherein the forehead support and the chin support consist at least partly of a soft foam plastics material.

7. The portable headrest according to claim 4, wherein the body of the portable headrest consists at least partly of a soft foam plastics material.

8. The portable headrest according to claim 4, wherein a contact surface between the body of the headrest and the forehead support and/or the chin support is slanted in such a way that the forehead support and/or chin support can be adjusted in height and length by displacement along a longitudinal axis of the portable headrest.

9. The portable headrest according to claim 1, wherein the portable headrest has a body which has at its underside a rigid plate which extends over at least a portion of the underside.

10. The portable headrest according to claim 1, wherein the portable headrest further comprises at least one camera which is arranged in the recess between the forehead support and chin support.

11. The portable headrest according to claim 10, wherein the at least one camera is movably arranged in the recess between the forehead support and the chin support.

12. The portable headrest according to claim 1, wherein the headrest comprises a rounded attachment.

13. The portable headrest according to claim 12, wherein the rounded attachment has the shape of a spherical cap.

14. The portable headrest according to claim 12, wherein the rounded attachment has a flat plane and is attachable with the flat plane to an underside of a body of the headrest.

15. The portable headrest according to claim 14, wherein the rounded attachment has fixing means which are able to co-operate with complementary receiving means on or in the underside of the body of the headrest.

16. The portable headrest according to claim 15, wherein the fixing means are snap-in elements which are arranged on the flat plane of the rounded attachment and are able to snap into complementary receiving elements on or in the underside of the body of the headrest.

17. A method for supporting the head of a patient comprising providing a portable headrest according to claim 1.

18. The portable headrest according to claim 2, wherein the portable headrest has a body, and the forehead support and/or the chin support are formed separately from the body of the headrest, wherein the forehead support and/or the chin support have displacement elements, and the body of the portable headrest has at least one displacement element that is complementary to the displacement elements of the forehead support and/or the chin support.

19. The portable headrest according to claim 3, wherein the portable headrest has a body, and the forehead support and/or the chin support are formed separately from the body of the headrest, wherein the forehead support and/or the chin support have displacement elements, and the body of the portable headrest has at least one displacement element that is complementary to the displacement elements of the forehead support and/or the chin support.

20. The portable headrest according to claim 2, wherein the forehead support and the chin support consist at least partly of a soft foam plastics material.
